(19) United States
(12) Patent Application Publication
(10) Pub. No.: US 2017/0062159 A1
(43) Pub. Date: Mar. 2, 2017

(54) MEMS REED SWITCH DEVICE

(71) Applicant: Innovative Micro Technology, Goleta, CA (US)

(72) Inventor: Benedikt ZEYEN, Santa Barbara, CA (US)

(73) Assignee: Innovative Micro Technology

(21) Appl. No.: 15/237,120

(22) Filed: Aug. 15, 2016

Related U.S. Application Data
(60) Provisional application No. 62/210,299, filed on Aug. 26, 2015.

(51) Int. Cl. H01H 36/00

(52) U.S. Cl. CPC H01H 36/0013; H01H 2036/0093

(57) ABSTRACT

A MEMS device, having two flexible, permeable members which are manufactured to have sub-millimeter dimensions using MEMS fabrication procedures. The flexible, permeable members may form a reed switch, which closes an electrical connection in the presence of a magnetic field, and opens the connection otherwise. The MEMS reed switch device may be made using a three-wafer architecture of a lid wafer, a device wafer, and a lower, supporting wafer.

### CROSS REFERENCE TO RELATED APPLICATIONS

This is a non-Provisional U.S. patent application claiming priority to U.S. Provisional Patent Application Ser. No. 62/210,299, filed Aug. 26, 2015, and incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

This invention is directed to MEMS switch devices.

The reed switch is an electrical switch actuated by an applied magnetic field. The reed switch may contain a pair (or more) of magnetizable, flexible, metal reeds whose end portions are separated by a small gap when the switch is open. These macro-sized reed switches may be hermetically sealed in opposite ends of a tubular glass envelope.

The contacts may be normally open, closing when a magnetic field is present, or normally closed and opening when a magnetic field is applied. The switch may be actuated by a coil, making a reed relay, or by bringing a magnet near to the switch. Once the magnet is pulled away from the switch, the reed switch will go back to its original position.

Reed switches are widely used for electrical circuit control, particularly in the communications field. Reed switches actuated by magnets are commonly used in mechanical systems as proximity sensors. Examples are door and window sensors in burglar alarm systems and tamper proofing methods.

The reed switch principle can be applied to switch a wide variety of loads ranging from nanovolts to kilovolts, femtoamperes to amperes, and DC to radio frequency. In contrast to Hall effect devices, which have very limited ranges of outputs and generally do not control a final device, reed sensors can withstand higher voltage than typical Hall devices.

One important quality of the switch is its sensitivity, the amount of magnetic field necessary to actuate it. Sensitivity is measured in units of Ampere-turns, (A-t) corresponding to the current in a coil multiplied by the number of turns. Typical pull-in sensitivities for commercial devices are in the 10 to 60 A-t range. The lower the A-t, the more sensitive the reed switch. Also, smaller reed switches, which have smaller parts, are more sensitive to magnetic fields, so the smaller the overall size of the reed switch, the more sensitive it is. Reeds which are smaller may also be less stiff, requiring a less energetic field to move them.

Accordingly, reed switches which were heretofore generally made of macroscopic components, and have dimensions on the order of millimeters, had relatively poor sensitivity.

### SUMMARY

Accordingly, it may be desirable to shrink the size of the reed switch in order to reduce the range of sensitivity to lower values. We describe here a reed switch device that may be fabricated using MEMS fabrication techniques, and thus may be made exceedingly small. Microelectromechanical systems (MEMS) are very small moveable structures made on a substrate using lithographic processing techniques, such as those used to manufacture semiconductor devices. MEMS devices may be moveable actuators, sensors, valves, pistons, or switches, for example, with characteristic dimensions of a few microns to hundreds of microns.

The MEMS reed device may include two flexible, permeable members that are deflected in the presence of a magnetic field. When a magnetic field is applied in the proper orientation, the permeable members are drawn towards areas of maximum field gradient. In one embodiment, as they are deflected by these magnetic forces, they may come into contact with one another, closing a circuit electrically. In other embodiments, the MEMS reed switch may be configured in a normally closed architecture, such that the switch opens rather than closes on application of a magnetic field. In yet another embodiment, the MEMS reed switch may be configured as a single pole double throw switch.

Accordingly, a microfabricated MEMS reed switch may include a first flexible, magnetically permeable member formed on a surface of a substrate, at least one additional, magnetically permeable member also formed on the same substrate and disposed in a position adjacent the first flexible, magnetically permeable member, and at least two electrical contacts that, together with the flexible, magnetically permeable members form a portion of a electric circuit.

The MEMS reed switch may be fabricated on three wafers. A lid wafer may cover the moving components, a device wafer may have the components formed therein, and the device may be supported by a third support wafer.

These and other features and advantages are described in, or are apparent from, the following detailed description.

### BRIEF DESCRIPTION OF THE DRAWINGS

Various exemplary details are described with reference to the following figures, wherein:

FIG. 1a is plan view of a first exemplary embodiment of a MEMS reed switch; FIG. 1B is a top-down view;

FIG. 2a is plan view of a second exemplary embodiment of a MEMS reed switch; FIG. 2b is a top-down view;

FIG. 3a is plan view of a third exemplary embodiment of a MEMS reed switch; FIG. 3b is a top-down view; FIG. 3c is a polar plot of the directional sensitivity of the MEMS reed switch shown in FIGS. 3a and 3b;

FIG. 4 is plan view of a fourth exemplary embodiment of a MEMS reed switch; and

FIG. 5 is schematic illustration of some exemplary dimensions for a MEMS reed switch.

It should be understood that the drawings are not necessarily to scale, and that like numbers maybe may refer to like features.

### DETAILED DESCRIPTION

In the systems and methods described here, a reed switch may be made from a pair of magnetically permeable, flexible members, using MEMS lithographic techniques. Accordingly, the features may be made exceedingly small, having sub-millimeter dimensions, and batch fabricated on a wafer in an economical fashion. When a magnetic field (from an electromagnet or a permanent magnet) is applied to the microfabricated, permeable, flexible members, the members may be urged to come together, thus completing an electrical circuit. The stiffness of the reeds causes then them to separate, and open the circuit, when the magnetic field is withdrawn.

Other configurations may contain a non-permeable members in addition to permeable members. Devices may be normally closed (contacts which open when the field is applied), or normally open (contacts which are closed when the field is applied). Yet another embodiment may be a microfabricated reed switch in single pole, double throw configuration. The fabrication, exemplary dimensions, and operation of these embodiments are described further below.

In any or all embodiments, good electrical contact may be obtained by plating a thin layer of highly conductive material over at least the contact portions of the permeable, flexible members. Low-resistivity silver (Ag) or corrosion-resistant gold (Au) may be used for this purpose. Accordingly, the microfabricated MEMS reed switch may have at least two electrical contacts which are plated with at least one of gold (Au) and silver (Ag).

As will be described below, the permeable, flexible members and contacts of the MEMS reed switch may be sealed away from the atmosphere, and thus protected against ambient conditions, shock and vibration. The hermetic sealing of a reed switch make them suitable for use in otherwise corrosive atmospheres. The MEMS reed switches disclosed here may be built as a three-wafer stack, with microfabricated nickel iron beams forming the permeable, flexible members on a device layer encapsulated by a lid wafer and a lower support wafer. This architectural allows a simple version of the reed switch with side leads as shown in a first embodiment, and a second embodiment using top contacts for bumping, and a third embodiment having higher directional sensitivity. Lastly, the architecture can also allow a bipolar reed switch, that is, a single pole double throw switch using the same basic MEMS architecture. The geometry described below may be made on a 2×1×1 mm cube die, allowing very economical manufacturing

The permeable material forming the flexible members may be nickel-iron Permalloy, which has a composition of between about 60% and about 90% Ni and 40% and 10% iron. The most common composition is 80% Ni and 20% Fe, which has a relative permeability of about 8,000. Of course, other permeable materials may be used as well. Accordingly, the microfabricated MEMS reed switch may have a first flexible permeable member and a second flexible permeable member comprising nickel-iron. More specifically, the nickel-iron may comprise nickel-iron permalloy, having a composition of 80% Ni and 20% Fe. A permeable material, as used herein, should be understood to mean a magnetically responsive material with a relative permeability of at least 100. A flexible member should be understood to mean a member with a length and width, which is deflected when a microNewton force is exerted at its distal end, by an amount of at least about 10% of its width.

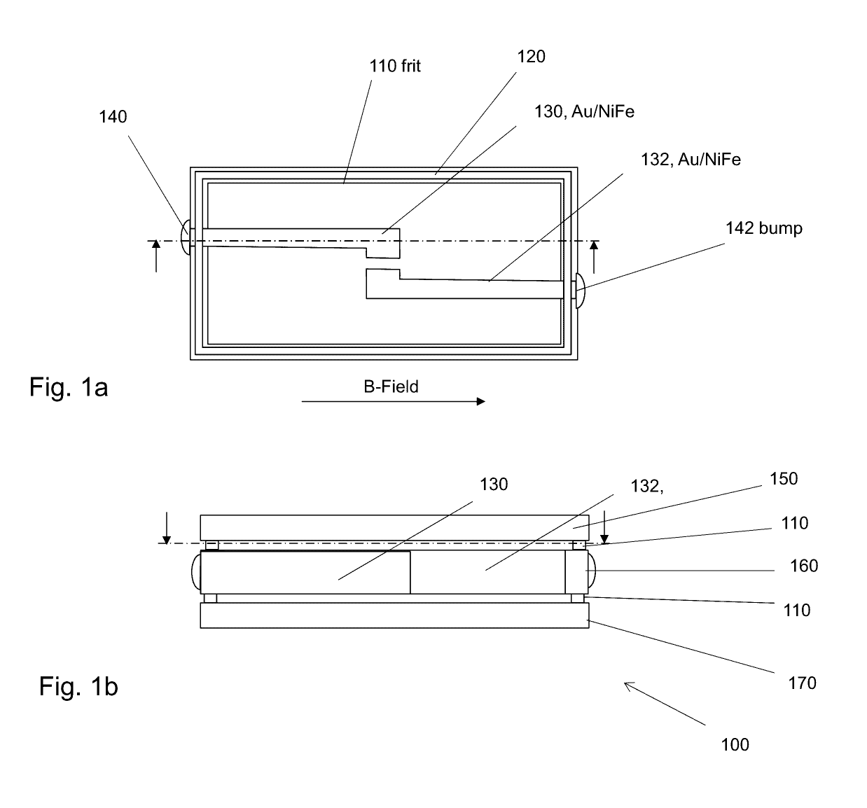

FIG. 1a is a plan view of a first exemplary embodiment of a MEMS reed switch 100. In FIG. 1a, reference number 110 corresponds to an adhesive bond line that joins two or more wafers. Reference number 120 corresponds to a raised feature, for example, a silicon nitrate raised feature under the bondline 110. Reference number 130 corresponds to a first permeable magnetic flexible member, which responds to an externally applied magnetic field. Opposing the first permeable magnetic flexible member 130 is a second permeable magnetic flexible member 132.

The raised feature 120 which can function as a monorail within the bond. The purpose of the raised feature 120 is to encourage the formation of a hermetic seal around the device. The purpose of bondline 110, which may be a glass frit adhesive, is to join the plurality of substrates that is used to form this device. Other adhesive materials may also be used to bond the wafers, such as gold, metal alloys, SLID bonds, and the like. The purpose of raised feature within a bond line has been disclosed elsewhere, including U.S. Pat. No. 7,569,926, issued Aug. 4, 2009 and incorporated by reference in its entirety.

Reference number 140 refers to an electrically conductive bump, which allows electrical access from the exterior to the interior of the device. Specifically, bump 140 provides a site for electrical connection to the flexible permeable member 130 and bump 142 provides a site for electrical connection to flexible permeable member 132, both inside the bondline 110.

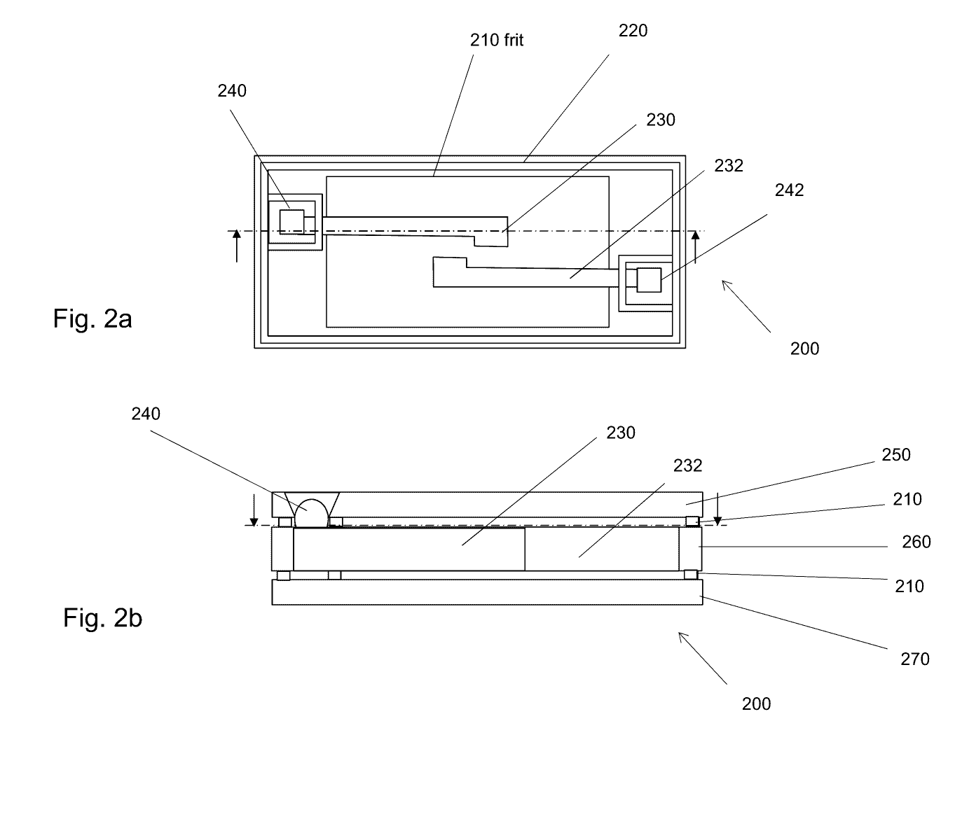

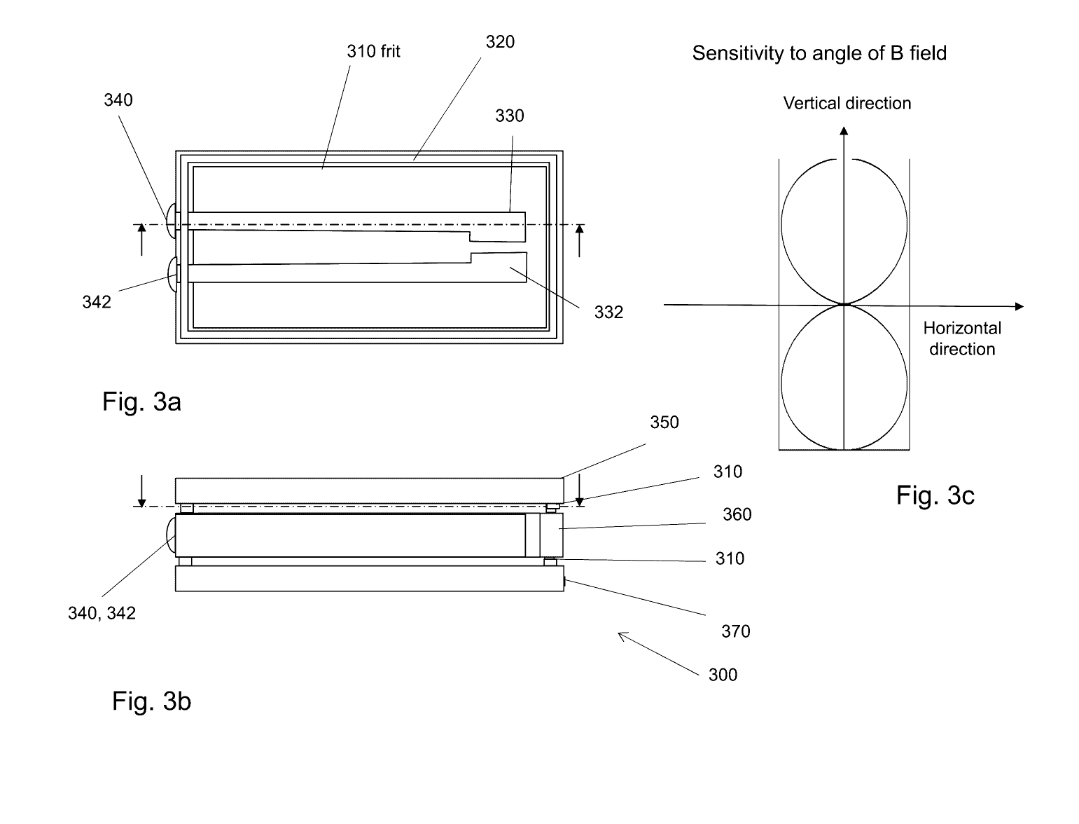

The dashed line shown in FIG. 1a is the view point perspective for the top down view shown in FIG. 1b. Similarly, the dashed line in FIG. 1b is the cross-section through which the plan view and shown in FIG. 1a is. Subsequent FIGS. 2a, 2b, 3a and 3b are similarly labelled. As before, in FIG. 1b, reference number 110 corresponds to a adhesive bond line that joins two or more wafers. Reference number 120 corresponds to a silicon nitrate raised feature. Reference number 130 corresponds to the first permeable magnetic flexible member, and 132 to the second flexible, permeable member. Each of the flexible, permeable members is responsive to an externally applied magnetic field, as described further below.

FIG. 1b also shows the three-wafer architecture mentioned previously. In this design, a top substrate 150 provides an encapsulating wall, which is bonded to a device layer 160, and then subsequently also to a lower supporting substrate 170, as shown in FIG. 1b. The microfabricated MEMS reed switch may therefore have the first flexible permeable member and the second flexible permeable member formed on a device wafer and supported on a support wafer, and enclosed with a lid wafer.

These structures 110-170 together constitute reed switch device 100. The functioning of the embodiment of the MEMS-fabricated reed switch will be described next with respect to FIGS. 1a and 1b.

When a magnetic field is applied in the direction shown in FIGS. 1a and 1b, the permeable flexible members 130 and 132 are drawn toward one another, as is well-known from basic magnetostatics. Members made of permeable magnetic materials tend to be drawn towards areas of rapidly changing magnetic flux density and toward one another, so as to reduce the overall reluctance of the device. Resisting this tendency is the spring force of the member. When the two members touch one another, an electrical connection is established between bump 140 and bump 142.

When the magnetic field is withdrawn, the flexible members return to their original positions because of the spring force built into the design of the device. Before application of the magnetic field, a gap may exist between the one member 130 and the second member 132. When the magnetic field is withdrawn, the flexible members return to their original positions, such that a gap exists between the one member 130 and the second member 132. Therefore the switch may be in the closed configuration with the application of an magnetic field, and in the open circuit configuration when the field is withdrawn.

The following manufacturing process can be used to make the device shown in FIGS. 1a and 1b.

For the device wafer 160 (Silicon):
DRIE contacts
Deposit seed, plate Au contact and barrier, plate NiFe traces
Grind/CMP to level
Print bond line
Frit bond or anodic bond 1^{st} lid (TOX/Glass wafer)
Grind/CMP back side until metal comes out
DRIE or KOH etch cavity
Frit or LT bond lid 2^{nd} wafer (TOX wafer/Glass)

Back end
Dice
Bump on sides

Another alternative back end method may be found below.
Partial dice
Shadow mask liftoff of contact traces around sidewalls and top
Bump
Full dice

FIG. 2a is the plan view of the second exemplary embodiment of a MEMS reed switch 200. Similar to FIG. 1a, in FIG. 2a reference number 210 refers to a bonding material, 220 refers to a raised feature. 230 refers to a first permeable, flexible, electrically conductive member, whereas reference number 232 refers to a second, opposing permeable member. In this second embodiment, the first permeable, flexible, electrically conductive member 230 may be laterally displaced from the second permeable, flexible, electrically conductive member 232, such that they do not touch precisely at the ends of member 230 and 232. This embodiment may be preferable for higher current densities travelling from first member 230 to second member 232.

Reference number 240 refers to an electrical bump to which an electrical connection is made, and reference number 242 refers to a second bump to which electrical connection is made.

FIG. 2b is a top view of the second exemplary embodiment. As before with FIG. 1a, reference numbers 250, 260 and 270 refer to the three wafers involved in the construction of MEMS reed device 200. 250 is the top wafer, 260 is the device wafer and 270 is the lower support wafer. Accordingly, the microfabricated MEMS reed switch may have the first flexible permeable member and the second flexible permeable member formed on a device wafer and supported on a support wafer, and enclosed with a lid wafer. Wafers 250, 260 and 270 may be joined by bonding material 210, which maybe a glass frit material. Embedded in the glass 210 may be the raised feature 220, which in some embodiments may be a monorail as described above.

Another difference between the second embodiment of device 200 and the first embodiment device 100 is the placement and location of the bumps 240 and 242, relative to bumps 140 and 142. In the first embodiment shown in FIG. 1a, the electrical bumps are located on the outside of the device. In contrast, in the second exemplary shown in FIG. 2a, the bumps are within the footprint of the device, and are available through the top wafer 250 as shown in FIG. 2a. Accordingly, the microfabricated MEMS reed switch may have electrical contacts which are electrically connected to bumps. The bumps may then be disposed within a footprint of the microfabricated MEMS reed switch.

An exemplary manufacturing process is described below for the device 200 shown in FIGS. 2a and 2b:

Lid wafer 250 (Silicon LPCVD SiNx)
Pattern access holes, KOH etch
Back side Grind/CMP to open
LPCVD SiNx passivation

Main wafer 260 (Silicon)
DRIE contacts
Deposit seed, plate Au contact and barrier, plate NiFe traces
Grind/CMP to level
Print bond line
Frit bond or anodic bond base (Si/Glass wafer)
Grind/CMP back side until metal comes out
DRIE or KOH etch cavity
Frit bond lid wafer
Deposit bump seed through shadow mask
Bump
Dice

FIG. 3a is a plan view of a third exemplary embodiment of a MEMS reed switch. In this embodiment, the opposing permeable flexible members 330 and 332 are mirror images of one another and directly opposing one another. In FIG. 3a, the two flexible members 330 and 332 maybe disposed directly adjacent one another, and as a mirror image, rather than staggered and adjacent as shown in FIGS. 1a and 2a. Because of this architecture, the third embodiment may have higher directional sensitivity to the applied magnetic field. The sensitivity as shown in FIG. 3c, as will be explained below. A combination of the manufacturing methods set forth above with respect to FIGS. 1a, 1b, 2a and 2b may be used to manufacture the third exemplary embodiment shown in FIG. 3.

FIG. 3a is the plan view of the third exemplary embodiment of a MEMS reed switch 300. Similar to FIG. 1a, in FIG. 3a reference number 310 refers to a bonding material, 320 refers to a raised feature. 330 refers to a first permeable, flexible, electrically conductive member, whereas reference number 332 refers to a second, opposing permeable member. In this third embodiment, the first permeable, flexible, electrically conductive member 330 may be the mirror image of the second permeable, flexible, electrically conductive member 332, and in the quiescent state, the ends of members 330 and 332 do not touch. This embodiment may be preferable for higher current densities travelling from first member 230 to second member 232.

Reference number 340 refers to an electrical bump to which an electrical connection is made to flexible member 330, and reference number 342 refers to a second bump to which electrical connection is made to flexible member 332.

FIG. 3b is a top view of the second exemplary embodiment. As before with FIGS. 1a and 2a, reference numbers 350, 360 and 370 refer to the three wafers involved in the construction of MEMS reed device 300. 350 is the top wafer, 360 is the device wafer and 370 is the lower wafer. Wafers 350, 360 and 370 may be joined by bonding material 310, which maybe a glass frit material. Embedded in the glass 310 may be a raised feature 320, which in some embodiments may be a monorail as described above.

FIG. 3c is a polar plot showing the directional sensitivity of the MEMS reed switch shown in FIGS. 3a and 3b. When a magnetic field is applied horizontally, the overall reluctance is reduced only minimally if at all, as the permeable flexible members 330 and 332 are drawn toward one another. As a result, the sensitivity to a horizontally applied magnetic field is also minimal, as illustrated in FIG. 3c. However, if the field is applied vertically, a more substantial reduction in reluctance occurs if the permeable flexible members 330 and 332 are drawn toward one another. Accordingly, the embodiment shown in FIGS. 3a and 3b have an anisotropic sensitivity, that is, the device is more sensitive to field applied in a particular direction. In other words, The microfabricated MEMS reed switch may have a sensitivity which is a function of an angle between an axis of the switch and the direction of the applied magnetic field. This variable sensitivity may be at a minimum when the applied field is parallel to the axis, and at a maximum when the applied field is orthogonal to the axis.

As with the other embodiments, when the magnetic field is withdrawn, the flexible members return to their original positions because of the spring force built into the design of the device. Before application of the vertical magnetic field, a gap may exist between the one member 130, 230 and 330 and the second member 132, 232 and 332. When the magnetic field is withdrawn, the flexible members return to their original positions, such that a gap exists between the one member 130, 230 and 330 and the second member 132, 232 and 332. Therefore the switch may be in the closed position with the application of an magnetic field, and in the open circuit configuration when the field is withdrawn.

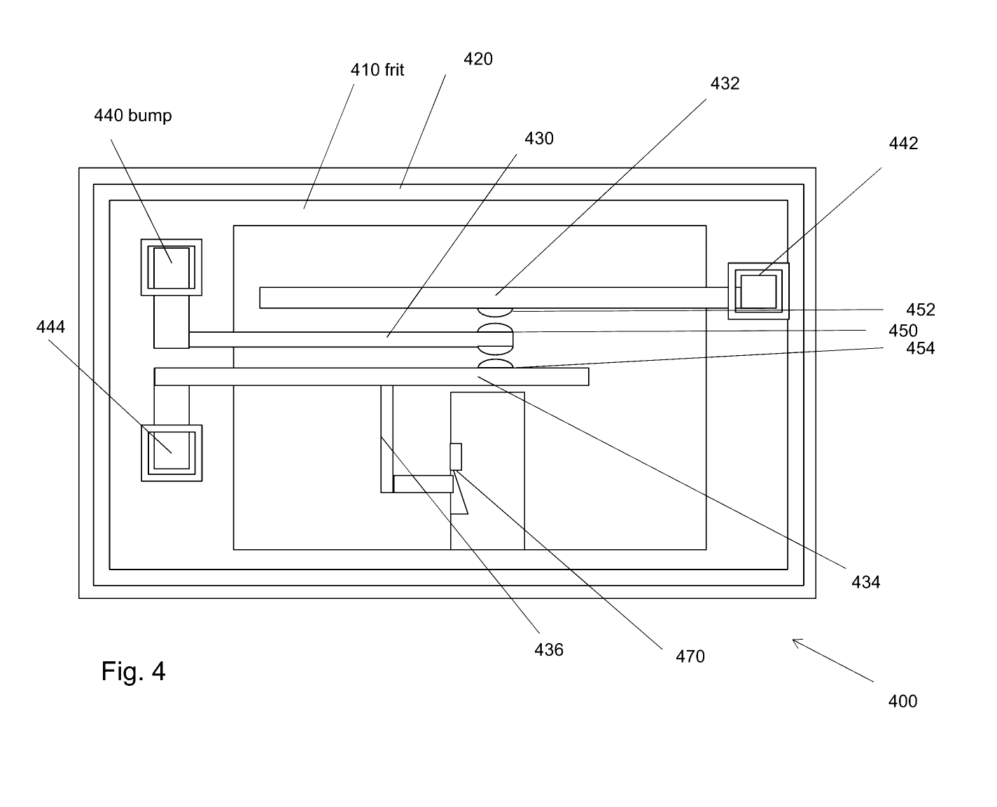

FIG. 4 is a plan view of a fourth exemplary embodiment of a MEMS reed switch 400. In this embodiment, the switch is may be of the single pole double throw sort, wherein a single deflectable lever can close either of two sets of contacts. As in the previous embodiments, 410 is the bonding adhesive, 420 is the raised feature which may be located within the bondline. Reference number 440, 442 and 444 refer to electrical bumps, and serve an analogous purpose to bumps 140, 240 and 340. 430 is a first flexible permeable member, 432 is a second flexible member, and 434 is a third flexible member, which may all be made of a permeable material such as nickel iron permalloy. The third flexible member may define another electrode of the microfabricated MEMS reed switch.

Flexible member 434 may be put into a state of tension by application of a magnetic field in the horizontal direction. This field will draw flexible member 434 up and into contact with flexible permeable member 430. Tab 436 attached to flexible permeable member 434 can then enter slot 470, which may latch tab 436 into this position. In this position, contact 440 may been in electrical connection with contact 444, i.e. the circuit between 440 and 444 is closed by a magnetic field applied in the horizontal direction. Accordingly, the device shown in FIG. 4 may remain in a closed position, with flexible, permeable members 430 and 432 in contact even when the device 400 suffers a shock or vibration.

If a magnetic field is then applied in the vertical direction, the reluctance may be minimized by having flexible permeable member 430 move in the upward direction and into contact with flexible permeable member 432. This will then open the circuit between 440 and 444, and close the circuit between 440 and 442. The force may be sufficient to overcome the deflection imposed by the latched flexible member 434. Accordingly, the embodiment shown in FIG. 4 may be a single pole, double throw switch.

It should be apparent that other switching mechanisms and configurations are possible based on the teachings herein. For example, double pole double throw switches may be made using these design concepts. Switches that are latching or nonlatching are contemplated.

Flexible permeable members may also be combined with nonmagnetic structures which do not respond to an applied magnetic field. They may also be combined with permanent magnets, which have a permanent magnetization associated with them. For example, the third flexible member in this embodiment may be nonmagnetic.

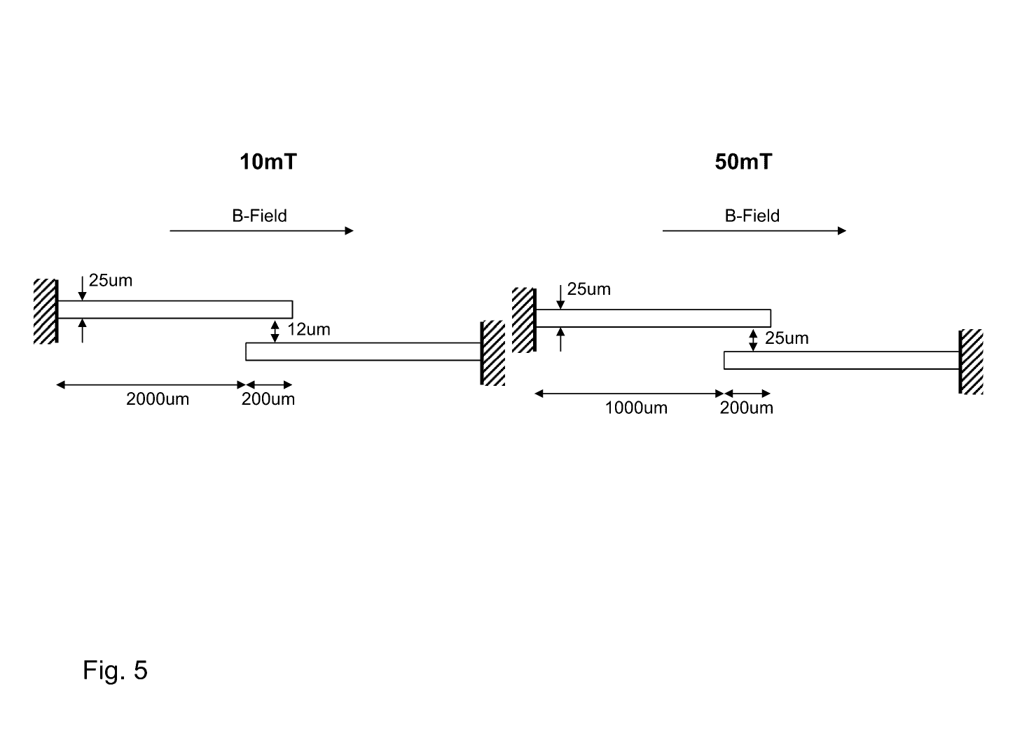

FIG. 5 show some exemplary dimensions for the flexible permeable members 130, 132, 230, 232, 330, 332, 430, 432 and 434. As shown in FIG. 5, each of the flexible beams may be about 25 μm in thickness with the gap, or separation of about 12 microns. The length of the members may be about 2000 μm, and the overlap between the beams 130, 132, 230, 232, 330, 332, 430, and 432 may be about 200 μm. These dimensions may be appropriate for an applied field on the order of 10 milliTesla.

Alternatively, each of the dimensions shown in FIG. 5 may be scaled, according to the anticipated size of a magnetic field to be applied. As shown in FIG. 5b, the length of the beams 130, 132, 230, 232, 330, 332, 430, 432 and 434 may be 1000 μm again with the thickness of 25 μm and gap separation of 25 μm. This configuration may be better suited for stronger magnetic fields on the order of 50 milliTesla.

Accordingly, as can be seen from the above description, a microfabricated MEMS reed switch may be formed, such that the first flexible, permeable member and the at least one additional flexible, permeable member are deflected in the presence of a magnetic field. In one embodiment, the first flexible, permeable member and the at least one additional flexible member may touch, at which point an electrical connection is formed and a switch is closed. In another embodiment, the microfabricated MEMS reed switch may be formed such that when the first flexible, permeable member and the at least one additional flexible member touch, an electrical connection is severed and a switch is opened.

In some embodiments, the microfabricated MEMS reed switch may be formed such that the two flexible, permeable members are disposed with each end directly adjacent. Alternatively, the microfabricated MEMS reed switch may be formed such that the two flexible, permeable members are disposed with each end overlapping and adjacent. Alternatively, the microfabricated MEMS reed switch may be formed such that the two flexible, permeable members are disposed as mirror images across a symmetry axis. The microfabricated MEMS reed switch may further include a locking mechanism which holds at least one of the flexible, permeable members in a predefined position when the magnetic field is withdrawn. The microfabricated MEMS reed switch may be configured as a single pole, double throw switch, as described above. A microfabricated MEMS reed switch is also contemplated wherein the three flexible members are configured as a double pole, double throw switch.

It should be understood that these embodiments are exemplary only, and many other embodiments may be contemplated, and still fall within the scope of this invention. So while various details have been described in conjunction with the exemplary implementations outlined above, various alternatives, modifications, variations, improvements, and/or substantial equivalents, whether known or that are or may be presently unforeseen, may become apparent upon reviewing the foregoing disclosure.

What is claimed is:

1. A microfabricated MEMS reed switch device comprising:
a first flexible, magnetically permeable member formed on a surface of a substrate;
at least one additional, magnetically permeable member also formed on the same substrate and disposed in a position adjacent the first flexible, magnetically permeable member; and
at least two electrical contacts that, together with the flexible, magnetically permeable members form a portion of an electric circuit.

2. The microfabricated MEMS reed switch of claim 1, wherein the first flexible, permeable member and the at least one additional flexible, permeable member are deflected in the presence of a magnetic field.

3. The microfabricated MEMS reed switch of claim 2, wherein when the first flexible, permeable member and the at least one additional flexible member touch, an electrical connection is formed and a switch is closed.

4. The microfabricated MEMS reed switch of claim 2, wherein when the first flexible, permeable member and the at least one additional flexible member touch, an electrical connection is severed and a switch is opened.

5. The microfabricated MEMS reed switch of claim 2, further comprising a locking mechanism which holds at least one of the flexible, permeable members in a predefined position when the magnetic field is withdrawn.

6. The microfabricated MEMS reed switch of claim 2, wherein when flexible, permeable members are configured as a single pole, double throw switch.

7. The microfabricated MEMS reed switch of claim 2, wherein when the two flexible, permeable members are disposed with each end directly adjacent.

8. The microfabricated MEMS reed switch of claim 2, wherein when the two flexible, permeable members are disposed with each end overlapping and adjacent.

9. The microfabricated MEMS reed switch of claim 2, wherein when the two flexible, permeable members are disposed as mirror images across a symmetry axis.

10. The microfabricated MEMS reed switch of claim 1, further comprising a third flexible member that defines another electrode of the microfabricated MEMS reed switch.

11. The microfabricated MEMS reed switch of claim 1, wherein the at least two electrical contacts are plated with at least on of gold (Au) and silver (Ag).

12. The microfabricated MEMS reed switch of claim 1, wherein the first flexible permeable member and the second flexible permeable member are not touching in the absence of a magnetic field, and thus the switch is normally open.

13. The microfabricated MEMS reed switch of claim 10, wherein the third flexible member is non-magnetic.

14. The microfabricated MEMS reed switch of claim 1, wherein the first flexible permeable member and the second flexible permeable member are formed on a device wafer and supported on a support wafer, and enclosed with a lid wafer.

15. The microfabricated MEMS reed switch of claim 1, wherein the first flexible permeable member and the second flexible permeable member comprise nickel-iron.

16. The microfabricated MEMS reed switch of claim 15, wherein the nickel-iron comprises nickel-iron permalloy, having a composition of 80% Ni and 20% Fe.

17. The microfabricated MEMS reed switch of claim 1, wherein the electrical contacts are electrically connected to bumps which are disposed within a footprint of the microfabricated MEMS reed switch.

18. The microfabricated MEMS reed switch of claim 1, wherein the sensitivity of the MEMS reed switch is a function of an angle between an axis of the switch and the direction of the applied magnetic field.

19. The microfabricated MEMS reed switch of claim 18, wherein the sensitivity of the microfabricated MEMS reed switch is at a minimum when the applied field is parallel to the axis, and at a maximum when the applied field is orthogonal to the axis.

20. The microfabricated MEMS reed switch of claim 10, wherein the three flexible members are configured as a double pole, double throw switch.
